(19) United States
(12) Patent Application Publication
(10) Pub. No.: US 2021/0354369 A1
(43) Pub. Date: Nov. 18, 2021

(54) SHELL AND FILL FABRICATION FOR THREE-DIMENSIONAL (3D) PRINTING

(71) Applicant: Tak Hong Guan, Palo Alto, CA (US)

(72) Inventor: Tak Hong Guan, Palo Alto, CA (US)

(21) Appl. No.: 16/874,404

(22) Filed: May 14, 2020

(51) Int. Cl. B29C 64/124; B29C 64/336; B29C 64/205; B29C 64/393

(52) U.S. Cl. CPC B29C 64/124; B29C 64/336; B33Y 10/00; B29C 64/393; B29C 64/205

(57) ABSTRACT

In one embodiment, a method for fabricating a three-dimensional (3D) object is provided. The method includes an operation for depositing, by a shell builder, a first material to form a base of the 3D object. The method further includes an operation for depositing, by the shell builder, the first material to form a wall of the shell of the 3D object. The method includes a further operation for dispensing space filling fluid into a void defined by the shell using a dispenser. Advantages and benefits of this operation include achieving time savings as compared to conventional material extrusion processes. Additionally, the method includes an operation for depositing, by the shell builder, the first material on top of the space filling fluid to form a top layer of the 3D object.

### BACKGROUND

3D printing covers a variety of processes, in which material is joined or solidified under computer control to create a three-dimensional object, with material being added together (such as liquid molecules or powder grains being fused together), typically layer by layer. It is different from conventional machining, casting and forging processes, where material is either removed from a stock item (subtractive manufacturing) or poured into a mold and shaped by means of dies, presses and hammers.

3D printing techniques were considered suitable only for the production of functional or aesthetic prototypes and a more appropriate term for it was rapid prototyping. Lately, the precision, repeatability and material range have increased to the point that some 3D-printing processes are considered viable as an industrial-production technology, whereby the term “additive manufacturing” can be used synonymously with “3D printing”. One of the key advantages of 3D printing is the ability to produce very complex shapes or geometries hard for conventional manufacturing processes to accommodate.

The most-commonly used 3D-printing process is a material extrusion technique called Fused Deposition Modeling (FDM). While FDM technology was invented after the other two most popular technologies, Stereo-Lithography (SLA), and Selective Laser Sintering (SLS); FDM is typically the most inexpensive of the three by a large margin, which lends to the popularity of the process.

The prerequisite for producing any 3D printed part is a digital 3D model or a CAD file. These 3D model files need to be processed by a piece of software called a “slicer,” which converts the model into a series of thin layers and produces a G-code file containing instructions tailored to specific type of 3D printer (e.g. FDM printers). This G-code file can then be used by 3D printing control software (which loads the G-code and uses it to instruct the 3D printer during the 3D printing process). Printing an object with contemporary methods can take anywhere from several hours to several days, depending on the process used and the size and complexity of the model, as well as the properties of the material.

While traditional techniques like injection moulding can be less expensive for manufacturing polymer products in high quantities after the high cost and time/effort of making molds are amortized, additive manufacturing can be faster, more flexible and less expensive when producing relatively small quantities of parts since there is no mold making.

The layered structure of all Additive Manufacturing processes leads inevitably to a strain-stepping effect on part surfaces which are curved or tilted with respect to the building platform. The effects strongly depend on the orientation of a part surface inside the building process.

Some printing techniques require internal support to be built for overhanging features during construction. These supports must be mechanically removed or dissolved upon completion of the print.

Traditionally, 3D printing focused on polymers for printing, due to the ease of manufacturing and handling polymeric materials. However, the method has rapidly evolved to not only print various polymers but also materials such as metals and ceramics. The following table illustrates some examples of 3D printing systems.

| Major Types | Representative Technologies | Representative Materials |
|---|---|---|
| Material | Fused deposition modeling (FDM) or | Thermoplastics, eutectic metals, edible |
| Extrusion | Fused filament fabrication (FFF) | materials, etc. |
| Light | Stereolithography (SLA) | Photopolymer |
| polymerized | Digital Light Processing (DLP) | Photopolymer |
| | Continuous Liquid Interface | Photopolymer + thermally activated |
| | Production (CLIP) | chemistry |
| Powder Bed | Powder bed and inkjet head 3D | Almost any metal alloy, powdered |
| | printing (3DP) | polymers, Plaster |
| | Selective laser sintering (SLS) | Thermoplastics, metal powders, ceramic |
| | | powders |
| | Direct metal laser sintering (DMLS) | Almost any metal alloy |
| Others | Laminated object manufacturing, | Paper, metal foil, plastic film, almost |
| | Powder fed Directed Energy | any metal alloy |
| | Deposition, etc. | |

### Fused Filament Fabrication (FFF) AKA Fused Deposition Modeling (FDM)

Fused filament fabrication (FFF), also known under the trademarked term Fused Deposition Modeling (FDM), derives from automatic polymeric foil hot air welding system, hot-melt gluing and automatic gasket deposition. After Stratasys' s patent on this technology expired, a large open-source development community developed and both commercial and DIY variants utilizing this type of 3D printer appeared. As a result, the price of this technology has dropped significantly, and it has become the most common form of 3D printing.

In fused deposition modeling, the model or part is produced by extruding small beads or streams of material which harden immediately to form layers. A filament of thermoplastic or other low melting point material or mixture is fed into an extrusion nozzle head (3D printer extruder), where the filament is heated to its melting temperature and extruded onto a build table. More recently, fused pellet deposition (or fused particle deposition) has been developed, where particles or pellets of plastic replace the need to use filament.

The nozzle head heats the material and turns the flow on and off. Typically, stepper motors or servo motors are employed to move the extrusion head and adjust the flow. The printer usually has 3 axes of motion. A computer-aided manufacturing (CAM) software package is used to generate the G-Code that is sent to a microcontroller which controls the motors.

Plastic is the most common material for such printing. Various polymers may be used, the most common are acrylonitrile butadiene styrene (ABS), and polylactic acid (PLA). In general, the polymer is in the form of a filament fabricated from virgin resins. Metal and glass may both be used for 3-D printing as well, though they are much more expensive and generally used in processes other than FDM.

FDM has some restrictions on the variation of shapes that may be fabricated. For example, FDM usually cannot produce stalactite-like structures, since they would be unsupported during the build. To handle these restrictions, thin supports are added to the structure, which have to be broken away during finishing. This can be done manually, but usually, the slicer software takes care of the addition of these supports.

### Molding and Casting

Casting is a manufacturing process in which a liquid material is usually poured into a mold containing a hollow cavity of the desired shape, and then allowed to solidify. The solidified part is also known as a casting, which is ejected or broken out of the mold to complete the process. Casting materials are usually metals or various time setting materials that cure after mixing two or more components together; examples are epoxy, concrete, plaster and clay. Casting is most often used for making complex shapes that would be otherwise difficult or uneconomical to make in high volume by other methods. Heavy equipment like machine tool beds, ships' propellers, etc. can also be cast in the required size, rather than fabricating by joining several small pieces.

A mold (or mould), a hollowed-out block that is filled with a liquid or pliable material such as plastic, glass, metal, or ceramic raw material, may have been made using a pattern or model of the final object. The liquid hardens or sets inside the mold, adopting its shape. A mold is the counterpart to a cast. The very common bi-valve molding process uses two molds, one for each half of the object. Articulated moulds have multiple pieces that come together to form the complete mold, and then disassemble to release the finished casting; they are expensive, but necessary when the casting shape has complex overhangs. Piece-molding uses a number of different molds, each creating a section of a complicated object. This is generally only used for larger and more valuable objects.

A release agent is typically used to make removal of the hardened/set substance from the mold easily. Typical uses for molded plastics include molded furniture, molded household goods, molded cases, and structural materials.

These methods of fabrication have drawbacks. It is in this context that embodiments described here arise.

### SUMMARY

The following detailed description and accompanying drawings provide a better understanding of the nature and advantages of the present disclosure.

In one embodiment, a method for fabricating a three-dimensional (3D) object is provided. The method includes an operation for depositing, by a shell builder, a first material to form a base of the 3D object. The method further includes an operation for depositing, by the shell builder, the first material to form a wall of the shell of the 3D object. Moreover, the method includes an operation for dispensing space filling fluid into the shell using a dispenser. Additionally, the method includes an operation for depositing, by the shell builder, the first material on top of the space filling fluid to form a top layer of the 3D object.

### BRIEF DESCRIPTION OF THE DRAWINGS

FIG. 1 illustrates an overall flow of a method for shell and fill fabrication (SFF) with the shell building process and the filling process alternating, according to various embodiments.

FIG. 2 shows an overall flow of a method for SFF with the concurrent shell building and filling processes, according to one embodiment.

FIG. 3 shows a sample object that may be built using fused deposition modeling (FDM) and SFF methods, according to various embodiments.

FIGS. 4A-4F show various steps for building the object using conventional FDM with full infill, provided as a basis for comparison to SFF.

FIGS. 5A-5F show various steps for building the object using FDM with partial infill, provided as a basis for comparison to SFF.

FIGS. 6A-6I show various steps for building the object using alternating SFF, according to one embodiment.

FIGS. 7A-7I show various steps for building the object using concurrent SFF, according to one embodiment.

FIG. 8 shows a three-dimensional model of an SFF system used for carrying out SFF, according to one embodiment.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident to one skilled in the art, based on the language of the different claims, that the claimed subject matter may include some or all of the features in these examples, alone or in combination, and may further include modifications and equivalents of the features and techniques described herein.

Embodiments described herein provide for a shell and fill fabrication (SFF) process, for machines such as 3-dimensional (3D) printers capable of implementing SFF, and for computer programs capable of instructing an appropriate machine to implement SFF. Advantages of SFF as compared to other fabrications methods will now be discussed.

3D printing processes such as Fused Deposition Modeling (FDM), is very slow and produces weak parts. Other 3D printing processes such as Selective Laser Sintering, material jetting, stereolithography, require expensive equipment and industrial vs residential settings due to added safety concerns.

Alternative processes combining 3D printed molds and casting is typically a complex multi-step process, subjected to the mold design and casting removal constraints e.g. no undercuts. Unlike SFF, no process today combines mold/shell building and casting in one concurrent step.

Traditional casting is expensive because molds are hard to make. Molds are typically machined from blocks of hard material (usually metal). Molds also need to preserve intricate external details while observing constraints that allows for mold removal and cast ejection e.g. no undercuts. SFF is not subjected to these constraints. Only the external surface of the shell has the intricate features if the model has them, the internal surface serves only to retain the casting material while it cures. Also, unlike a mold, the shell does not need to be removed.

Subtractive Manufacturing by hand tools or using CNC machines is a wasteful, expensive and time consuming process due to the need for high power high precision machinery, so to cut/shape blocks of hard material such as metal.

FDM lays down thin lines of melted plastic repeatedly, line by line, layer by layer. Using FDM to construct an object is time consuming as filling volume with thin lines is very slow. FDM materials are usually thermoplastics that are generally quite weak. As a result of the layering process, it also introduces additional structural weakness along the Z-axis orientation.

SFF fills internal space with liquid that solidifies in a timely manner. It should remain in a viscous liquid state so that it can flow and fill all the internal cavity easily under gravity alone, and then cured into solid to provide structural support for the next shell layer. This is done in a predictable and controllable process such as natural or controlled cooling i.e. temperature, chemistry (e.g. careful choice and mixing of hardener to epoxy), or exposure to ultraviolet light in the case of photoresins. This is significantly faster than repeatedly laying down thin lines. The use of a separate casting material from the filament used to build the shell can lead to a much stronger finished object. Note that concurrently building shell while pouring casting material speeds up and simplifies the overall process, especially for one off or low volume manufacturing.

Embodiments contemplated here leverage the ability of FDM to print intricate patterns at or near the outer surface of an object with the speed, cost savings, strength, and other advantages of casting. Embodiments of SFF presented are enabled to accomplish desired structures and surface intricacy without needing to first craft a mold. Moreover, embodiments of SFF are enabled to accomplish such structures in less time and with much greater strength than conventional FDM processes. In one sense, SFF may be thought of as printing a mold in real-time, e.g., concurrently with a casting process.

In one embodiment, an SFF process involves printing multiple vertical layers of a shell of a 3D object and then using a dispenser to dispense space filling fluid after those vertical layers are in place. This may be referred to herein as alternating SFF because the shell deposition process and the space filling process alternate and do not necessarily occur concurrently. For example, and in one embodiment, a 3D object may comprise a base, a vertical wall having multiple layers stacked on top of each other, and a top layer. Thus, in the alternating SFF embodiment, the base and the wall may be deposited first prior to any dispensing of space filling fluid. In this embodiment, the dispensing of space filling fluid process may wait until every component of the shell (e.g., the base and the wall) are deposited first. When the base and the wall are completed by the deposition process, the dispensing process may then be triggered such that an internal as yet empty volume is filled with space filling fluid. In this sense, the dispensing of space filling fluid may occur all in “one go.” In this embodiment, the alternating SFF process may wait for the space filling fluid to cure to an extent that it can provide support for the deposition of the top layer. Once cured, the space filling fluid provides a solid surface upon which the top layer may be deposited.

In other embodiments referred to as concurrent SFF, shell building and dispensing of space filling fluid occur at the same time for at least some duration of fabricating the 3D object. For example, a shell builder may be forming a portion of the wall while the dispenser is dispensing space filling fluid. Similar to the alternating SFF embodiments, concurrent SFF may wait for the space filling fluid to cure to an extent that it can provide support for the deposition of the top layer. The shell builder may then use the cured space filling fluid as a platform on which to form the top layer.

In certain embodiments, the space filling fluid may cure at uneven rates throughout the volume. For example, and in some embodiments, the space filling fluid once dispensed may cure faster toward the edges and more slowly toward the center of the volume. In these embodiments, the deposition of the top layer may begin toward the edges of the space filling fluid and move toward its center.

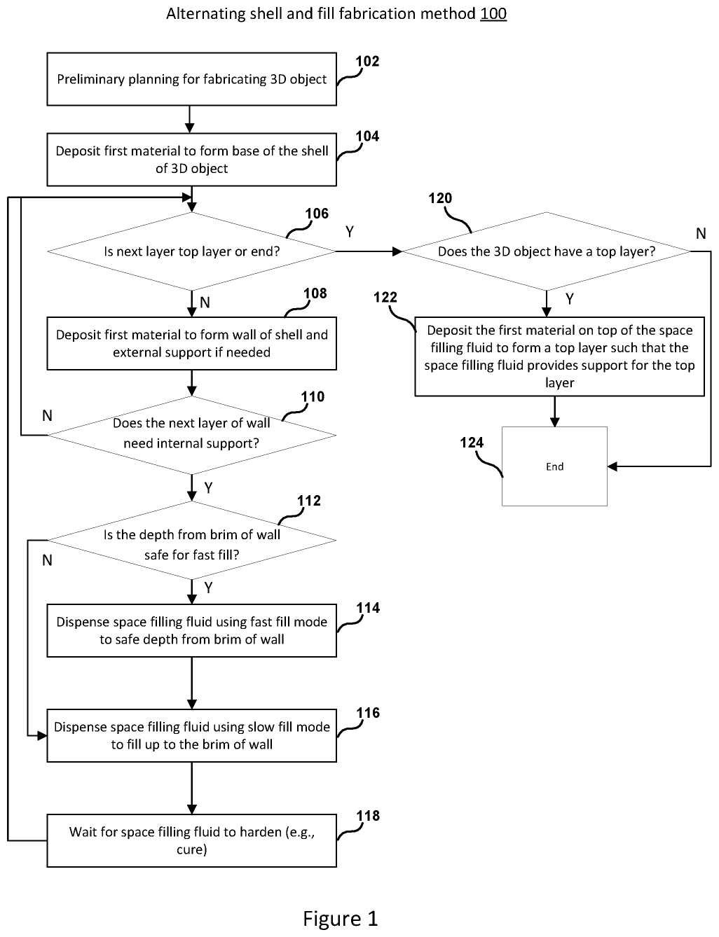

FIG. 1 illustrates an overall flow of a method 100 for shell and fill fabrication (SFF) with an alternating shell building process and filling process alternating, according to various embodiments. Method 100 is configured to alternate between shell building and filling during fabrication 3-dimensional (3D) objects.

The method begins, at step 102, with preliminary planning for fabricating the 3-dimensional (3D) object. At step 102, an SFF system converts a 3D object file into instructions for the SFF system to execute. For example, at 102, the SFF system analyzes a digital representation of the 3D object and determines what portions of the 3D object is to be fabricated with shell and what portions with fill. For example, if the 3D object is a cylinder, step 102 determined what portions of the cylinder are to be fabricated by the shell wall builder and what portions of the cylinder are to be fabricated by the dispenser.

Additionally, the SFF system determines the set of discrete steps for shell building and filling to fabricating the 3D object. This may include, for example, determining instructions for building a base of the 3D object, determining instructions for building external support structures for the 3D object, determining instructions for building a shell wall of the 3D object, determining instructions for building a top layer of the 3D object. Furthermore, at step 102, the SFF system determines the volumes of space filling fluid to fill into the 3D objects. Additionally, at step 102, the SFF system determines the heights and/or layers of wall that will require internal or external support. Once this determination is made, the SFF system may determine whether external support structures and internal space filling fluid steps are to be included in the fabrication plan to provide external and internal support, respectively.

As shown in FIG. 1, method 100 deposits, at step 104, a first material to form a base of the 3D object. The base of the 3D object is typically the bottom-most layer of object upon which other portions of the 3D object are built. For this reason, the base of the 3D object is typically built first. As noted above, the size and shape of the base are determined at step 102. In the cylinder example, step 104 may serve to build a base that has the shape of the cylinder base. In certain embodiments, the shell builder includes an FDM device. In these embodiments, the first material is thermoplastic material.

Method 100, at step 106, determines whether the next layer to be fabricated by the shell builder is the top layer or if the next step is an end to method 100 (e.g., when fabrication is finished). The next layer is a layer that is to be deposited by the shell builder on top of the most recently deposited layer. Thus, if the most recently deposited layer is the base, then the next layer may be a first layer of wall. As shown, if the next layer is determined not to be the top layer, method 100 proceeds to step 108. If, on the other hand, method 100 determines that the next layer is the top layer, then method 100 proceeds to step 120.

Method 100 deposits, at step 108, the first material to form a wall of the shell. Additionally, if method 100 determines that external support structures are needed at step 102, then method 100 deposits first material to form external support as well. In the present cylinder example, method 100 may deposit the first material on top of the cylinder base to form a cylindrical wall. For example, method 100 may deposit the first material the shape of a ring in order to form the cylindrical wall of the cylinder.

Method 100 determines, at step 110, whether the next layer of shell wall needs internal support. Internal support is needed when the shell wall cannot support itself against gravity. For example, when the 3D object has a shell wall with an internal overhang, the shell wall may require internal support. Internal support provides support for such structures. In the present cylinder example, no internal support would be necessary at least until the top layer is ready to be built. At step 110, if method 100 determines that no support is required, the method proceeds to step 106. Method 100 proceeds to iterate through steps 106-108 until either (1) the next layer is the top layer, or (2) if the next layer of wall requires internal support. If method 100 determines at step 110 that the next layer of shell wall requires internal support, method 100 proceeds to step 112.

Method 100 determines, at step 112, whether a depth from a brim of shell wall is safe for fast fill. The brim of the shell wall may be an upper edge of the shell wall. Fast fill is a method of dispensing space filling fluid that is relatively faster. However, the accuracy of volume that is dispensed is lower. The depth is measured from a height of a surface on which space filling fluid is dispensed and a height of the brim. The surface on which space filling fluid is dispensed may be an upper surface of the base of the 3D object or it may be an upper surface of a previously dispensed volume of space filling fluid. If method 100 determines that the depth is sufficient for fast filling, method 100 proceeds to step 114. If method 100 determines that the depth is insufficient for fast filling, method 100 proceeds to step 116.

Method 100 dispenses, at step 114, space filling fluid using the fast fill mode to a safe depth from the brim of the wall. In particular, step 114 is configured to dispense space filling fluid into an internal space defined by the shell wall and the base of the 3D object. Method 100 continues dispensing space filling fluid until a safe depth from the brim of the wall is reached. In the present cylinder example, the base and shell wall of the cylinder form a cup-like shape having a brim. Method 100 may dispense space filling fluid in the fast mode into the cup until a certain depth from the brim is reached. In one example, space filling fluid is dispensed in the fast fill mode until an upper surface of the volume dispensed is a few millimeters from the brim. Method 100 proceeds to step 116 once the safe depth has been reached by the space filling fluid.

At step 116, method 100 dispenses space filling fluid using a slow fill mode until the space filling fluid reaches the brim of the shell wall. The slow fill mode dispenses space filling fluid at a lower rate than the fast fill mode to achieve greater accuracy over an amount that is dispensed. In the present cylinder example, method 100 may dispense space filling fluid in the slow mode into the cup-like shape up to the brim of the shell wall. That is, method 100 may dispense space filling fluid until an upper surface of the volume dispensed is flush or substantially flush with the brim. Once method 100 dispenses space filling fluid up to the brim of the shell well, method 100 proceeds to step 118.

At step 118 method 100 waits for the space filling fluid to harden. The space filling fluid is a solid at lower temperatures (e.g., room-temperature) and a liquid at higher temperatures. At step 118, method 100 ensures that the space filling fluid becomes solid prior either building another layer of shell wall that requires internal support or building the top layer. In some embodiments, the duration to wait is calculated based on the amount of space filling fluid that has been dispensed and the composition of the space filling fluid.

Method 100 next proceeds to step 106 to determine whether the next layer is the top layer or if the fabrication instructions call for an end. If the next layer is not the top layer, method 100 iterates through steps 108-118. If the next layer is the top layer, method 100 proceeds to step 120.

At step 120, method 100 determines whether the 3D object has a top layer or not. As noted above, the top layer is a layer of the 3D object that is the topmost layer. In the present cylinder example, the top layer may include an upper base of the cylinder. If it is determined that there is no top layer, method 100 proceeds to end 124. In this scenario, an upper surface of the 3D object will include space filling fluid. If, on the other hand, step 120 determines that 3D object has a top layer, method 100 proceeds to step 122.

At step 122, method 100 deposits the first material on top of the space filling fluid to form a top layer. As noted above, since the space filling fluid has hardened at step 118, the space filling fluid provides a foundation on top of which the topmost layer may be deposited.

In the present cylinder example, the upper base is deposited on top of the hardened space filling fluid. Once the top layer is formed, the shell (e.g., the base, shell wall, and top layer) completely envelope the hardened space filling fluid. After step 122, method 100 proceeds to end 124.

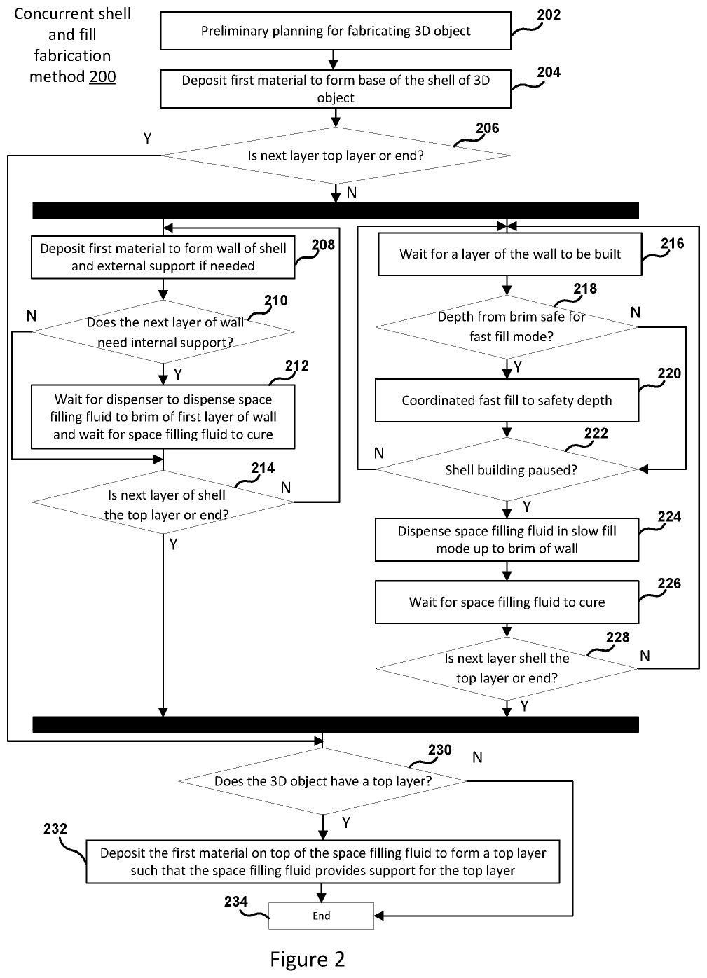

FIG. 2 shows an overall flow of a method 200 for SFF with concurrent shell building and filling (i.e., dispensing of space filling fluid) processes, according to one embodiment. Method 200 serves to perform the shell building process and the filling process concurrently for at least a portion of either processes. This is contrasted with method 100, which serves to alternate between shell building and filling processes.

As shown in FIG. 2, steps that are positioned between the black bars are configured to be implemented concurrently. For example, steps 208-214 are configured to be implemented concurrently with steps 216-228.

As shown, at step 202, method 200 performs preliminary planning for fabricating a 3D object. For example, method 200 converts a 3D object file into fabrication instructions for an SFF system to implement. In the present example, those instructions, when executed, instruct the SFF system to perform the shell building process and the filling process concurrently for at least some duration of time. For example, in some embodiments, shell building and dispensing space filling fluid will occur at the same time.

At step 204, method 200 deposits the first material to form a base of the shell of the 3D object. In the cylinder example, the base that is formed at step 204 may be the lower circular base. At step 206, method 200 determines whether the next layer is the top layer of if the next step is an end to method 200. As noted above, the next layer is a layer of first material that is to be deposited immediately on top of the most recently deposited layer. Additionally, as noted above, the top layer may be the topmost layer during the fabrication process.

If it is determined that the next layer is the top layer at step 206 (or if the next step is the end of method 200), method 200 proceeds to step 230. If instead it is determined that the next layer is not the top layer, method 200 proceeds to steps 208 and 216. At step 208, method 200 deposits the first material to form a wall of the shell of the 3D object. Additionally, first material is deposited to form external support if needed. As step 208 is being performed by method 200, step 216 is being performed concurrently. At step 216, method 200 waits for a layer of the wall to be built.

As shown, method 200 proceeds to step 210, at which method 200 determines whether the next layer of wall requires internal support. As noted above, internal support is needed when the 3D object has an internal overhang that cannot support its own weight. Whether or not an internal overhang requires internal support is a function of the following factors:
An angle of the overhang relative to the portion of wall the overhang protrudes from or relative to gravity;
A thickness of wall and the overhang;
A strength of the first material;
Geometry of the 3D object surrounding the overhang;
Overall geometry of the 3D object; and
Others.

If it is determined that the next layer of wall does not need internal support, method 200 proceeds to step 214. At step 214, method 200 determines whether the next layer to be deposited is the top layer or if the fabrication instructions call an end. If the next layer is not the top layer (and if the fabrication instructions do not call an end), steps 208-214 are iterated until several layers of wall are deposited. During this period of iterating through steps 208-214, steps 216-228 may be performed. That is, while method 200 performs shell building, it may concurrently perform dispensing of space filling fluid.

For example, while steps 208-214 are being implemented, method 200 may concurrently implement steps 216-228. Step 216 ensures that there is one or more layers of the wall into which space filling fluid may be dispensed. Next, at step 218, method 200 determines whether a depth from the brim of the wall is safe for fast fill mode. If it is determined that the depth from the brim is safe for fast fill, method 200 proceeds to step 220. At step 220, method 200 dispenses space filling fluid in the fast mode to a safety depth. Next, method 200 determines, at step 222, whether shell building has paused. If shell building has not paused at step 222, then steps 216-222 may be iterated as steps 208-214 are iterated. That is, method 200 dispenses space filling fluid while a next layer of wall is being deposited.

Once method 200 determines that the next layer of shell is the top layer or that the fabrications instructions call an end at step 214, shell building is paused. Method 200 determines that shell building is paused at step 222 and proceeds to step 224. At step 224, method 200 dispenses space filling fluid in slow fill mode up to the brim of the wall. Next, at step 226, method 200 waits for the space filling fluid to cure (e.g., harden). Once the space filling fluid has hardened, method 200 proceeds to step 228 to determine whether the next layer of shell or whether the fabrication instruction calls an end.

At this stage in method 200, method 200 determines that the next layer of shell is the top layer (or that the fabrication instructions call an end) at both steps 214 and 228. As a result, method 200 proceeds to step 230. At step 230, method 200 determines whether the 3D object has a top layer. As noted above, in some examples, 3D objects have a top layer of first material that is to be deposited on top of the hardened space filling fluid. In this manner, the shell (e.g., the combination of the base, wall and top layer) completely envelopes the space filling fluid. Other examples of 3D objects may lack a top layer formed by the first material. In these examples, the 3D object's topmost layer is instead defined by hardened space filling fluid. As a result, the space filling fluid is not completely enveloped by the shell of the 3D object.

If the 3D object is determined not to have a top layer at step 230 (e.g., in the example of the 3D object where the space filling fluid is not completely enveloped by the shell), method 200 proceeds to end 234. If the 3D object is determined to have a top layer at step 230 (e.g., in the example 3D object where the space filling fluid is completely enveloped by the shell), method 200 proceeds to step 232. At step 232, method 200 deposits the first material on top of the space filling fluid to form a top layer such that the space filling fluid provides support for the top layer. At step 232, the space filling fluid has already hardened (see step 226). As a result, the hardened space filling fluid provides a solid foundation on which the first material may be deposited. Once method 200 deposits the first material on top of the space filling fluid to form the top layer, method proceeds to end 234.

As noted above, the first material may be a thermoplastic material. When the thermoplastic material is heated above a certain temperature, it is liquefied and extrudable and malleable. The first material is configured to fuse with other layers of first material once it cools. That is, chemical bonds are formed between layers of first material.

In some embodiments, the first material also fuses with the space filling fluid once it hardens. For example, as the first material is deposited on top of the hardened space filling fluid, the first material may fuse with the hardened space filling fluid. In other embodiments, fusion between the first material and the space filling fluid is not necessary. For example, the first material may be deposited on top of the hardened space filling fluid without the first material fusing with the hardened space filling material.

The above description assumed that the 3D object did not have an internal overhang that is in need of internal support (e.g., “No” at step 210). The following describes a scenario where the 3D object needs internal support such as when the 3D object includes an internal overhang.

If, at step 210, it is determined that internal support is needed, method 200 proceeds to step 212. At step 212, method 200 waits for the dispenser to dispense space filling fluid to a brim of the wall. As step 212 occurs, method 200 proceeds from step 216 to step 218. If method 200 determines that the depth from the brim is safe for fast fill mode, method 200 proceeds to step 220. At step 220, method 200 dispenses space filling fluid in the fast fill mode to a certain depth. Next, method 200 proceeds to step 222 where it determines that the shell building process is paused because method 200 is also at step 212. Thus, method 200 proceeds to step 224 where it dispenses space filling fluid in the slow fill mode up to the brim of the wall. Next, method 200 waits for the space filling fluid to cure at step 226. Once the space filling fluid has cured, it may provide internal support for the next layer of wall. In this example, method 200 determines at step 228 that the next layer is not the top layer and that the fabrication instruction do not call an end. This is because the next layer to be built is a layer of wall requiring internal support. Thus, method 200 returns to step 216 to wait for the next layer of wall to be built.

Meanwhile, step 212 is complete because the space filling fluid has cured at step 226. In this example, method 200 determines at step 214 that the next layer of shell is not the top layer and that the fabrication instructions do not call an end. Again, this is because the next layer to be built is a layer of wall requiring internal support. Thus, method 200 returns to step 208 to deposit the first material to form the layer of the wall that was in need of internal support. If the next layer of wall is again in need of internal support, method 200 determines as much at step 210. Consequently, steps 212 and steps 218-228 are against iterated through. The result of iterating through steps 212 and steps 218-228 is the dispensing of another volume of space filling fluid that when hardened provides internal support for the next layer of wall. Steps 208-214 and steps 216-228 may be iterated for as many times as there are layers of wall requiring internal support. After the last layer requiring internal support is deposited at step 208, method 200 determines that the next layer does not require internal support at step 210. Method 200 continues until it is determined at both steps 214 and 228 that the next layer of shell to be deposited is the top layer or that the fabrication instructions call an end. When this occurs, method 200 proceeds to step 230 to determine whether the 3D object has a top layer. If no, method 200 proceeds to end 234. If yes, method 200 deposits first material on top of the space filling fluid to form a top layer at step 232. The space filling fluid, which as hardened at step 226, provides support for the first material at step 232. Finally, method 200 proceeds to end 234.

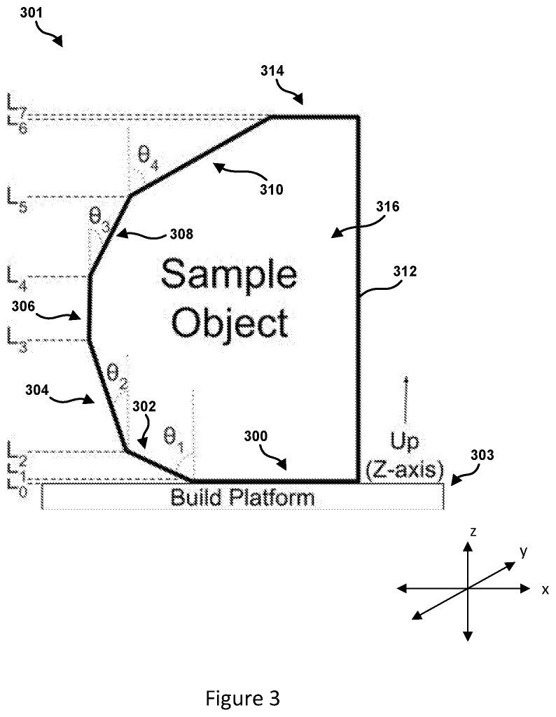

FIG. 3 shows a sample object 301 that may be built using fused deposition modeling (FDM) and SFF methods, according to various embodiments. As shown, sample object 301 is configured to be built upon a build platform 303. Sample object 301 includes base 300, wall layers 302-310, wall section 312, and top layer 314. Each of these sections are defined in terms of their z-coordinates L₀-L₇. Additionally, wall layers 302-304 and 308-310 are defined in terms of the angles θ₁₋₄ they form relative to the z-axis. Generally, when angles θ₁₋₄ are below a threshold angle, their corresponding wall layers may not require internal or external support. If θ₁₋₄ are above a threshold angle, their corresponding wall layers may require internal or external support. The threshold angle will vary depending on various factors, including:
A strength of the material used;
A weight of the material used;
Geometry of the 3D object surrounding the overhang;
Overall geometry of the 3D object; and
Others.
For the example shown in FIG. 3, it is assumed that the threshold angle is 45°.

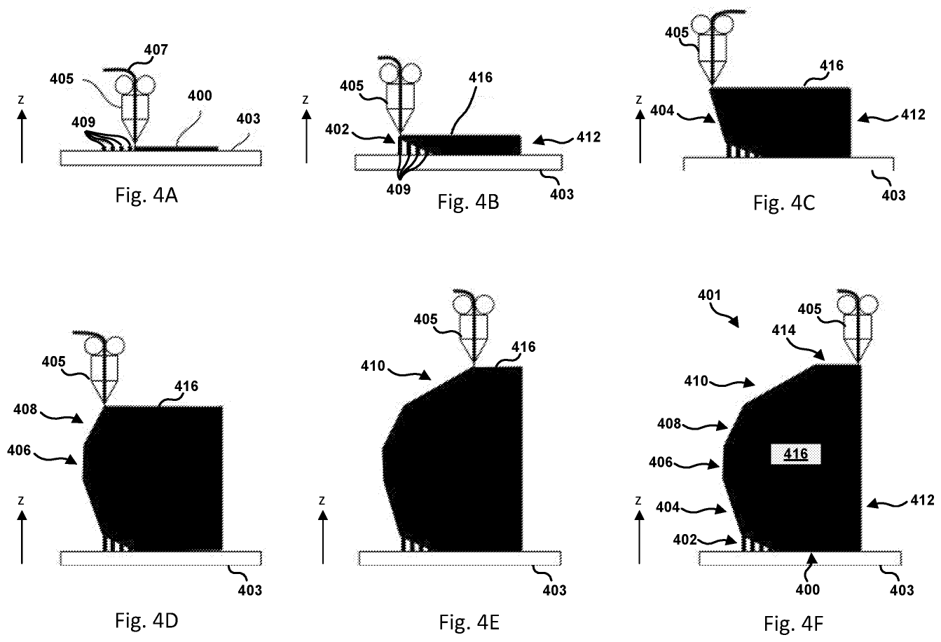

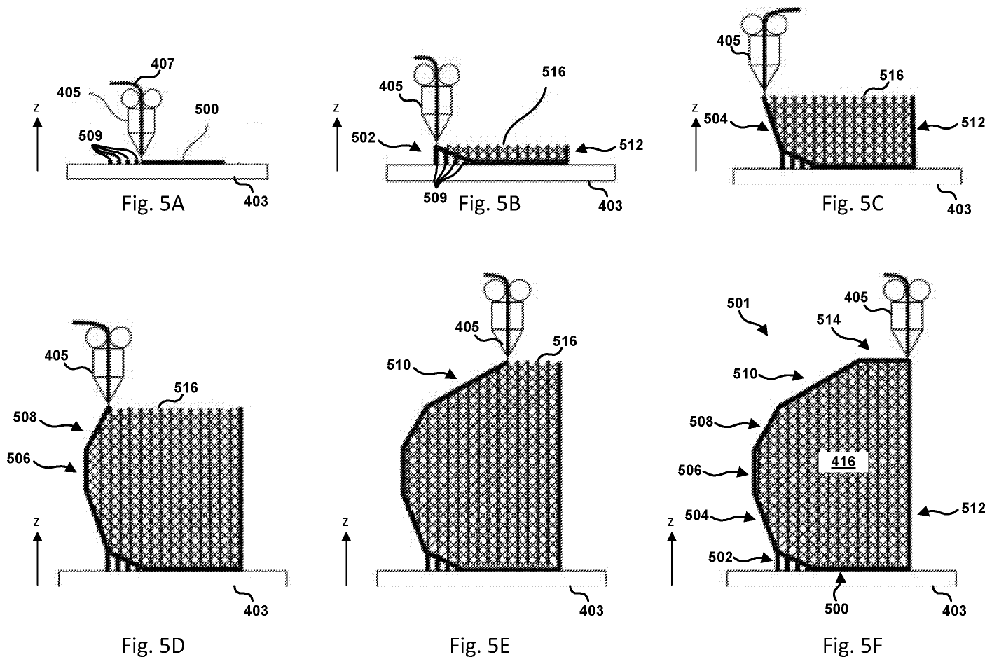

In the embodiment shown, base 300, wall layers 302-310, wall section 312 and top layer 314 may be fabricated using a first material such as a thermoplastic material. Sample object 301 also includes an internal portion 316, which may differ in composition depending upon whether FDM or SFF is used to fabricate sample object 301. If only FDM is used to fabricate sample object 301, internal portion 316 may be fabricated using the first material. In this embodiment, internal portion 316 may be fabricated using complete fill or partial infill, shown in FIGS. 4A-4F and FIGS. 5A-5F, respectively. If instead SFF is used, internal portion 316 may be fabricated using space filling fluid.

As shown, base 300 has a height defined between L₀-L₁. Wall layer 302 is shown to be defined between L₁-L₂. Additionally, wall layer 302 forms an angle θ₁ to the z-axis. Angle θ₁ is greater than the threshold angle and, as a result, external support is needed during fabrication of wall layer 302. As shown, wall layer 304 is defined between L₂-L₃. Wall layer 304 forms an angle θ₂ relative the z-axis that is less than the threshold angle. As a result, external support may not be required for fabricating wall layer 304. Wall layer 306 is shown to be defined between L₃-L₄. Since wall layer 306 is vertical in the z-axis, no internal nor external support is necessary for its fabrication. Wall layer 308 is defined between L₄-L₅ and forms an angle θ₃ relative to the z-axis. Angle θ₃is less than the threshold angle and, as a result, no internal support is required for its fabrication. Wall layer 310 is defined between L₅-L₆. Wall layer 310 forms an angle θ₄ relative to the z-axis. As a result, internal support is required for its fabrication. Top layer 314 is defined between L₆-L₇. Top layer 314 is a 90° relative to the z-axis. As a result, top layer 314 will require internal support during its fabrication. Wall section 312 is shown to be vertical. As a result, neither internal nor external support is required for its fabrication.

FIGS. 4A-4F, 5A-5F, 6A-6I, and 7A-7I show different processes of fabricating objects similar in shape to sample object 301. FIGS. 4A-4F show various steps for building object 401 using FDM with full infill, according to one embodiment. Object 401 is shown to be similar in shape to sample object 301. Object 401 includes base 400, wall layers 402-410, wall section 412, top layer 414, and internal portion 416. In the example shown, internal portion 416 comprises full infill.

As shown in FIG. 4A, extruder 405 deposits first material 407 on platform 403 to form base 400 of object 401. Additionally, as shown, extruder 405 also deposits first material 407 to form external support 409. External support 409 is deposited in FIG. 4A because wall layer 402 (shown in FIG. 4B) forms an angle that is greater than the threshold angle relative to the z-axis.

As shown in FIG. 4B, extruder 405 has deposited first material 407 to form wall layer 402. Wall layer 402 is shown to be supported by external support 409. Additionally, extruder 405 has deposited first material 407 to form a portion of wall section 412 and a portion of internal portion 416. Internal portion 416 is formed by depositing first material line by line and layer by layer. In some embodiments, the majority of time taken to fabricate object 401 to the state shown in FIG. 4B from the state shown FIG. 4A is spent forming the portion of internal portion 416. This is because the volume of the portion of internal portion 416 may be greater than the sum of wall layer 402 and the portion of wall section 412.

In FIG. 4C, extruder 405 has deposited first material 407 to form wall layer 404, another portion of wall section 412, and another portion of internal portion 416. In the example shown, no external support is formed for wall layer 404 because wall layer 404 is configured at an angle relative to the z-axis that is less than the threshold angle. To proceed from the state shown in FIG. 4B to that in FIG. 4C, the majority of time may have been spent on forming the portion of internal portion 416.

In FIG. 4D, extruder 405 has deposited first material 407 to form wall layers 406 and 408, another portion of wall section 412, and another portion of internal portion 416. Again, to proceed from the state shown in FIG. 4C to that shown in FIG. 4D, the majority of time may have been spent on forming the portion of internal portion 416.

In FIG. 4E, extruder 405 has deposited first material 407 to form wall layer 410, another portion of wall section 412, and another portion of internal portion 416. Here, wall layer 410 requires internal support because it is configured at an angle relative to the z-axis that is greater than the threshold angle. In the example shown, internal support is provided by the portion of internal portion 416. Again, the majority of time required to proceed from the state shown in FIG. 4D to that shown in FIG. 4E is used to form the portion of internal portion 416.

In FIG. 4F, extruder 405 has deposited first material 407 to form top layer 410. At this stage, fabrication of object 401 by extruder 405 is complete. As a result, object 401 may be removed from platform 403. In some embodiments, the majority of time spend fabricating object 401 is dedicated to forming internal portion 416.

FIGS. 5A-5F show various steps for building object 501 using FDM with partial infill, according to one embodiment. Object 501 is shown to be similar in shape to sample object 301 and object 401. Object 501 includes base 500, wall layers 502-510, wall section 512, top layer 514, and internal portion 516. In the example shown, internal portion 516 comprises partial infill have a lattice structure. The lattice structure has density that is a percentage of full infill shown in FIGS. 4A-4F. The pattern shown in FIGS. 5B-5F provides a general idea of the lattice structure. However, there are many possible patterns that may be used.

As shown in FIG. 5A, extruder 405 deposits first material 407 on platform 403 to form base 500 of object 501. Additionally, as shown, extruder 405 also deposits first material 407 to form external support 509. External support 509 is deposited in FIG. 5A because wall layer 502 (shown in FIG. 5B) forms an angle that is greater than the threshold angle relative to the z-axis. At this stage, object 501 is similar to object 401 shown in FIG. 4A.

As shown in FIG. 5B, extruder 405 has deposited first material 407 to form wall layer 502. Wall layer 502 is shown to be supported by external support 509. Additionally, extruder 405 has deposited first material 407 to form a portion of wall section 512 and a portion of internal portion 516. As shown, the portion of internal portion 516 has a lattice structure. As a result, it is formed in less time than the portion of internal portion 416 shown in FIG. 4B. Nonetheless, it may take significant time to form the portion of internal portion 516.

In FIG. 5C, extruder 405 has deposited first material 407 to form wall layer 504, another portion of wall section 512, and another portion of internal portion 516. In the example shown, no external support is formed for wall layer 504 because wall layer 504 is configured at an angle relative to the z-axis that is less than the threshold angle. To proceed from the state shown in FIG. 5B to that in FIG. 5C, the majority of time may have been spent on forming the portion of internal portion 516.

In FIG. 5D, extruder 405 has deposited first material 407 to form wall layers 506 and 508, another portion of wall section 512, and another portion of internal portion 516. Again, to proceed from the state shown in FIG. 5C to that shown in FIG. 5D, the majority of time may have been spent on forming the portion of internal portion 516.

In FIG. 5E, extruder 405 has deposited first material 407 to form wall layer 510, another portion of wall section 512, and another portion of internal portion 516. Here, wall layer 510 requires internal support because it is configured at an angle relative to the z-axis that is greater than the threshold angle. In the example shown, internal support is provided by the portion of internal portion 516. Again, the majority of time required to proceed from the state shown in FIG. 5D to that shown in FIG. 5E is used to form the portion of internal portion 516.

In FIG. 5F, extruder 405 has deposited first material 407 to form top layer 510. At this stage, fabrication of object 501 by extruder 405 is complete. As a result, object 501 may be removed from platform 403. In some embodiments, the majority of time spend fabricating object 501 is dedicated to forming internal portion 516.

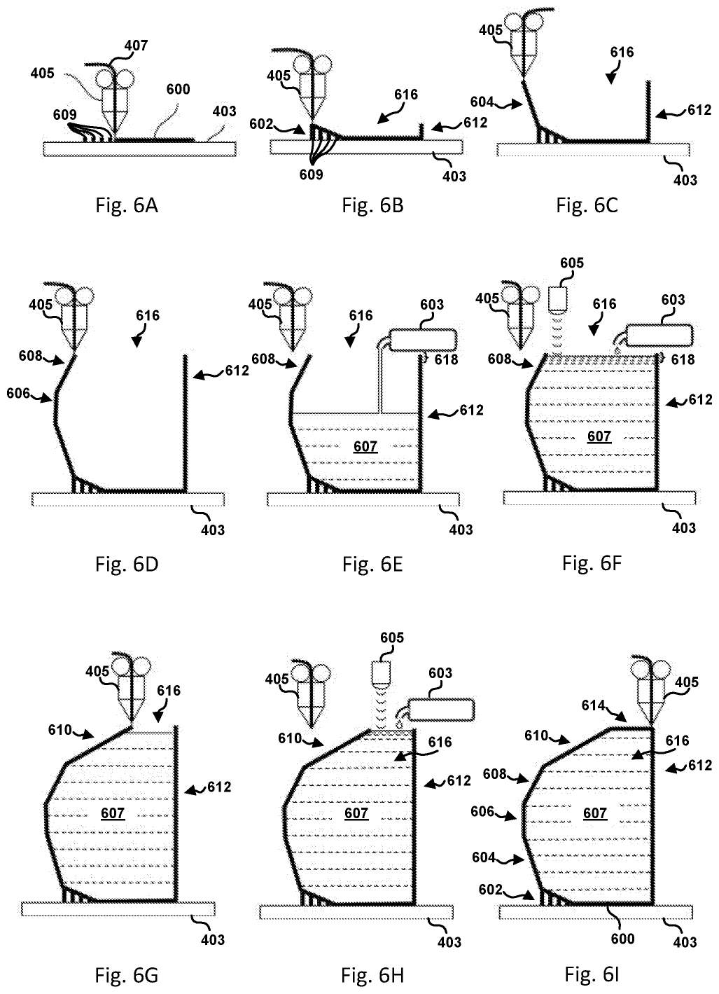

FIGS. 6A-6I show various steps used to build object 601 using alternating SFF, according to one embodiment. In the alternating SFF example shown, a shell building process alternates with a dispensing space filling fluid process. In other words, the shell building process and the dispensing process to not occur at the same time. Object 601 is shown in FIG. 6I to have the same external shape as sample object 301 and objects 401 and 501. However, internal portion 616 differs from internal portions 416 and 516 in its composition. In particular, internal portion 616 comprises space filling fluid as opposed first material (e.g., fused filament) that internal portions 416 and 516 comprise. Object 601 is also shown to include base 600, wall layers 602-610, wall section 612, and top layer 614. These components are similar to those of objects 401 and 501.

In FIG. 6A, extruder 405 has deposited first material 407 on platform 403 to form base 600 of object 601. Extruder 405 also deposits first material 407 on platform 403 to form external support 609. The processes leading up to the state of object 601 shown in FIG. 6A are similar to those leading up to that of objects 401 and 501 shown in FIG. 4A and 5A.

In FIG. 6B, extruder 405 has deposited fist material 407 to form wall layer 602, external support 609, and a portion of wall section 612. Contrasted with FIG. 4B and 5B, extruder does not deposit first material 407 to form a portion of the internal portion 616. Instead, the portion of internal portion 616 is left as an empty volume. The duration of fabrication to reach the stage shown in FIG. 6B is considerably less than the durations needed to reach the stages shown in FIGS. 4B and 5B.

In FIG. 6C, extruder 405 is shown to deposit first material to form wall layer 604 and another portion of wall section 612. Since wall layer 604 is configured at an angle relative to the z-axis that is less than the threshold angle, no external or internal support is necessary. Since no external support is necessary, external support 509 does not need to extend to support wall layer 604. Again, as shown, internal portion 616 is left as an empty volume in FIG. 6C.

In FIG. 6D, extruder 405 is shown to deposit first material to form wall layers 606 and 608 and another portion of wall layer 612. Wall layer 608 is shown to be angled internally. However, because wall layer 608 forms an angle relative to the z-axis that is less than the threshold angle, no internal support is needed. This is contrasted with wall layer 610, which does require internal support. Since wall layer 610 requires internal support, the wall layer 610 is not fabricated until the SFF process dispenses space filling fluid into internal portion 616 to provide the internal support (shown in FIGS. 6E-6F).

In FIG. 6E, dispenser 603 is shown to dispense space filling fluid 607 into internal portion 616. As dispenser 603 dispenses space filling fluid 607, extruder 405 is moved out of the way and does not deposit any first material. In the example shown, dispenser 603 may dispense space filling fluid 607 in the fast fill mode, which is denoted by the distance separating the illustrated dashed lines. Dispenser 603 continues to dispense space filling fluid 607 into internal portion 616 until space filling fluid 607 reaches depth 618 from a brim. The brim is formed by the upper edge of wall layer 608 and wall section 612. Once depth 618 is reached by space filling fluid 607, dispenser 603 switches to a slow fill mode shown in FIG. 6F.

In FIG. 6F, dispenser 603 is shown to dispense space filling fluid 607 in the slow fill mode from depth 618 to the brim. The dispensing of space filling fluid 607 in the slow mode is denoted by the tighter spacing of the illustrated dashed lines. In the embodiment shown, sensor 605 measures a height of space filling fluid 607 to ensure space filling fluid 607 reaches a desired height. Additionally, sensor 605 may prevent overflowing of space filling fluid 607. After dispenser 603 dispenses space filling fluid 607 up to the brim, the SFF process allows the space filling fluid to harden. Once hardened, space filling fluid 607 may provide internal support to wall layer 610.

In FIG. 6G, extruder 405 is shown to deposit first material to form wall layer 610 and wall section 612. Although not shown, the shell building and dispensing processes may have alternated several times to reach the stage shown in FIG. 6G. That is, dispensing space filling fluid 607 may have occurred several times to provide internal support for the next portion of wall section 610. This may be iterated until extruder 405 completes wall layer 610.

In FIG. 6H, extruder 405 has completed forming wall layer 610 and wall section 612. Extruder 405 is shown to move out of the way of dispenser 603. Dispenser 603 is shown to dispense space filling fluid 607 up to the brim formed by the upper edges of wall layer 610 and wall section 612. Sensor 605 is shown to measure a height of space filling fluid 607 during its dispensing to ensure that space filling fluid 607 reaches the brim and does not overflow. Once sensor 605 detects that the proper height of space filling fluid 607 is reached, it signals to the dispenser 603 to discontinue dispensing. At this stage, internal portion 616 is completely filled by space filling fluid 607. The SFF process is configured to allow space filling fluid 607 to cure prior to forming the top layer 614.

In FIG. 6I, space filling fluid 607 has hardened such that it can provide support for forming top 614. Dispenser 603 is shown to move out of the way of extruder 405. Extruder 405 may now deposit first material 407 to form top layer 614. At this stage, fabrication of object 601 is complete. As a result, object 601 may be removed from platform 403. Advantageously, the time taken to fabricate object 601 is less than that taken to fabricate objects 401 and 501. This is because the time it takes for the dispenser 603 to dispense space filling fluid 607 and for the space filling fluid 607 to harden is less than the time it takes to deposit first material to form internal portions 416 and 516.

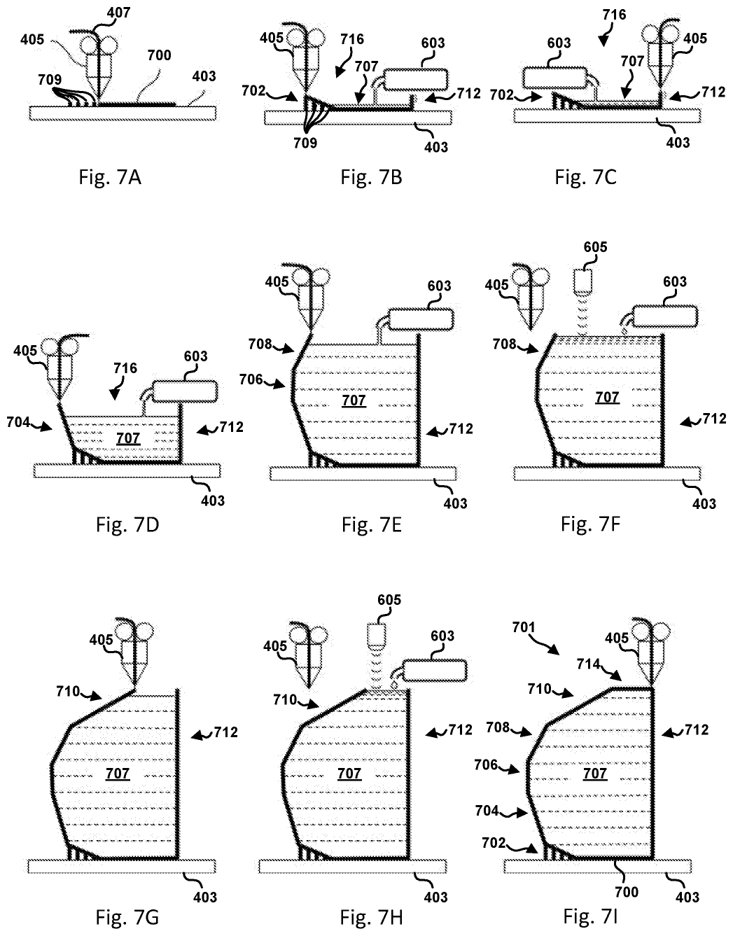

FIGS. 7A-7I illustrate various steps used to fabricating object 701 using concurrent SFF, according to one embodiment. In the concurrent SFF embodiment shown, shell building and dispensing space filling fluid occur simultaneously for some of the steps used to fabricate object 701. Object 701 is similar in composition to object 601. Object 701 differs from objects 401 and 501 in its internal portion 716, which comprises space filling fluid 716 as opposed to first material 417. Object 701 is shown to include base 700, wall layers 602-610, wall section 612, and top layer 614. These components are similar to those of objects 401 and 501.

In FIG. 7A, extruder 405 has deposited first material 407 on platform 403 to form base 700 of object 701. Also shown is extruder 405 depositing first material 407 on platform 403 to form external support 709. The processes leading up the state of object 701 shown in FIG. 7A are similar to the processes shown in FIGS. 4A, 5A, and 6A.

In FIG. 7B, extruder 405 is shown to deposit first material 407 to form wall layer 702. While extruder 405 is depositing first material 407 to form wall layer 702, dispenser 603 is shown to be dispensing space filling fluid 707 into internal portion 716. Dispenser 603 and extruder 405 are configured to not interfere with each other's processes. For example, as extruder 405 forms a portion of wall layer 702 on the left-hand side, dispenser 603 is moved to the right-hand side to dispense space filling fluid 707 from that location.

In FIG. 7C, extruder 405 has moved from forming wall layer 702 to forming wall section 712. As a result, extruder 405 moves from the left-hand side to the right-hand side of FIG. 7C. In response, dispenser 603 moves from the right-hand side to the left-hand side of FIG. 7C to dispense space filling fluid 707. In this manner, extruder 405 and dispenser 603 do not interfere with each other during the concurrent SFF process.

In FIG. 7D, extruder 405 is shown to be forming wall layer 704 and another portion of wall section 712. While this is occurring, dispenser 603 continues to dispense space filling fluid 707 into internal portion 716. Because wall layers 702 and 704 do not require internal support, there is no need to wait for space filling fluid 707 to harden prior to forming wall layers 702 and 704.

In FIG. 7E, extruder 405 has completed forming wall layers 706 and 708 and another portion of wall section 712. Meanwhile, dispenser 603 is continuing to dispense space filling fluid 707 into internal portion 716. The time taken to reach the state shown in FIG. 7E is less than the time taken to reach the state shown in FIG. 6E. This is because dispenser 603 in FIG. 7E has been dispensing space filling fluid 707 during formation of wall layers 702-708. In contrast, dispenser 603 in FIG. 6E has not been dispensing space filling fluid 607 during formation of wall layers 602-608. As a result, dispenser 603 in FIG. 6E must dispense a larger volume of space filling fluid 607 at the stage in FIG. 6E. Dispensing this larger volume of space filling fluid 607 takes time. Furthermore, in FIG. 7E, space filling fluid 707 has been given the opportunity to harden since the step shown in FIG. 7B. As a result, space filling fluid 707 may be closer to reaching a hardened state in FIG. 7E than space filling fluid 607 in FIG. 6E (which is freshly dispensed).

Since the next wall layer, wall layer 710, requires internal support, the concurrent SFF process may be configured to (1) ensure that the height of space filling fluid 707 is at or near the brim of wall layer 708 and an upper edge of wall section 712; and (2) that space filling fluid 707 has hardened prior to forming wall layer 710.

In FIG. 7F, extruder 405 is shown to be paused. Dispenser 603 is shown to dispense space filling fluid 707 in the slow fill mode such that space filling fluid 707 reaches the brim of wall layer 708 and the upper edge of wall section 712. Sensor 605 is shown to measure a height of space filling fluid 707 to ensure that space filling fluid reaches the brim. Once space filling fluid 707 reaches the brim, both extruder 405 and dispenser 603 are paused to wait for space filling fluid 707 to harden. Once hardened, space filling fluid 707 can provide internal support for wall layer 710.

In FIG. 7G, extruder 405 is shown to form wall layer 710. Wall layer 707 is supported by space filling fluid 707. Although not shown, the shell building and dispensing processes may have iterated several times to reach the stage shown in FIG. 7G.

In FIG. 7H, extruder 405 has completed forming wall layer 710 and wall section 712. At this stage, extruder 405 is paused and temporarily moves out of the way of dispenser 603. Dispenser 603 is shown to dispense space filling fluid 603 in the slow fill mode such that the height of space filling fluid 707 reaches a brim of the upper edges of wall layer 710 and wall section 712. Sensor 605 is shown to measure that height and communicates with dispenser 603 when that height is reached. In particular, once the height of the space filling fluid 707 reaches the brim, dispenser 603 discontinues dispensing space filling fluid 707. At this stage, the concurrent SFF process waits for space filling fluid 707 to cure prior to forming top layer 714.

In FIG. 7I, space filling fluid 707 has hardened and extruder 405 deposits first material on top of the hardened space filling fluid 707. That is, extruder 405 uses the hardened space filling fluid 707 as a foundation or solid surface upon which to form top layer 714. Once top layer 714 has been formed, object 701 is completed. As a result, object 701 may be removed from platform 403.

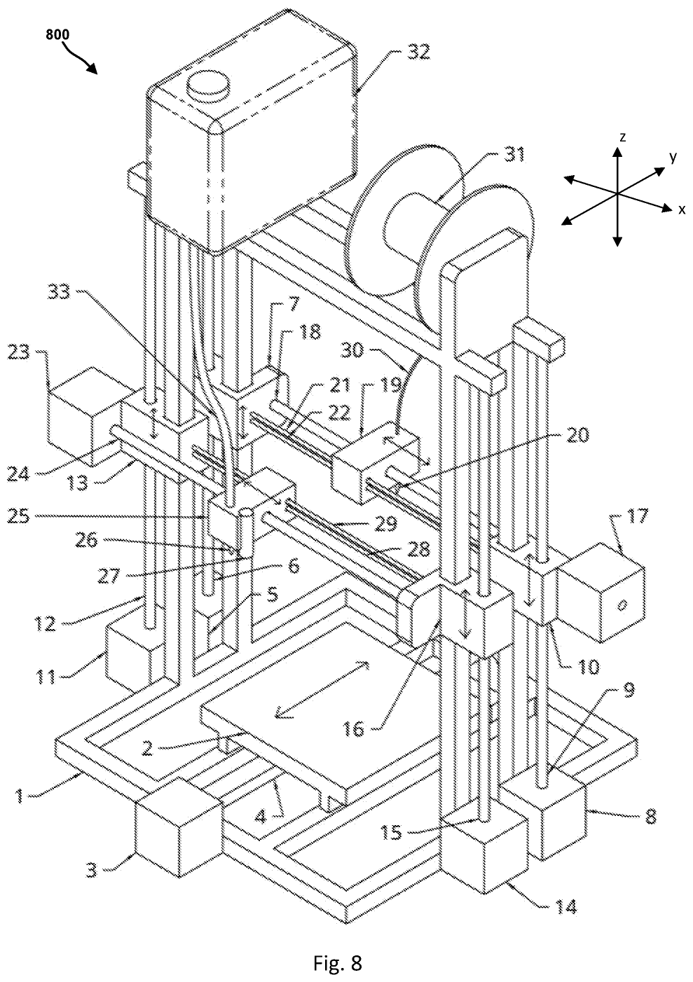

FIG. 8 shows an exemplary SFF system 800 that may be used to carry out SFF processes, according one embodiment. As shown, SFF system 800 includes frame 1, build platform 2, built platform y-axis stepper motor 3, and build platform y-axis lead screw 4. Platform 2 is configured to move in the y-axis but not in the x- or z-axes. Stepper motor 3 and lead screw 4 provide translational movement to platform 2. Platform 2 may correspond to platform 403.

Also shown in FIG. 8 are first extruder z-axis stepper motor 5, second extruder z-axis stepper motor 8, first extruder z-axis lead screw 6, second extruder z-axis lead screw 9, first extruder z-axis anchor 7, and second extruder z-axis anchor 10. Together, these components are configured to provide translational movement to extruder head housing 19 in the z-axis.

Also shown in FIG. 8 are extruder x-axis stepper motor 17, extruder x-axis lead screw 18, extruder head housing 19, extruder hot end nozzle 20, first extruder slider rod 21, and second extruder slider rod 22. Extruder x-axis stepper motor 17 and extruder x-axis lead screw 18 are configured to provide translational movement in the x-axis to extruder head housing 19 and extruder hot end nozzle 20. First and second extruder x-axis slider rods 21 and 22 provide support on which extruder head housing 19 and extruder hot end nozzle 20 slide in the x-axis. Extruder hot end nozzle 20 is configured to heat filament 30 and to deposit heated filament 30 to form the shell (e.g., the base, wall, and top layer) of a 3D object. Extruder head housing 19 may include (a) stepper motor for pulling or feeding filament 30, (b) heating and temperature sensor, and (c) cooling mechanisms such as cooling fan and heat sink, etc. Filament 30 is shown to be fed from filament spool 31, which may be freely spinning on a holder on top of the frame. Extruder head housing 19 and extruder hot end nozzle 20 may correspond to extruder 405.

Also shown in FIG. 8 are first dispenser z-axis motor 11, second z-axis dispenser motor 14, first dispenser z-axis lead screw 12, second dispenser z-axis lead screw 15, first dispenser z-axis anchor 13, and second dispenser z-axis anchor 16. Together, these components are configured to provide translational movement to dispenser housing 25 and dispenser nozzle 26.

As illustrated in FIG. 8, SFF system 800 further includes dispenser x-axis stepper motor 23, dispenser x-axis lead screw 24, dispenser head housing 25, dispenser nozzle 26, fill depth sensor 27, first and second dispenser slider rods 28 and 29, tank 32, and tube 33. Dispenser x-axis stepper motor 23 and dispenser x-axis lead screw 24 provide translational movement to dispenser head housing 25 and dispenser nozzle 26. First and second dispenser slider rods 28 and 29 provide support on which dispenser head housing 25 and dispenser nozzle 26 slide upon. Dispenser head housing 25 may include the following components (not shown): (a) a precision pump with flow metering sensor, (b) depth sensor reading component, (c) cleaning and/or purging component, (d) heating and/or temperature sensor, and (e) cooling fan and/or heat sink. Dispenser nozzle 26 is configured to dispense space filling fluid held in tank 32 via tube 33. Tube 33 may be flexible and configured to have a lot of give to allow for free movement of dispenser head housing 25 and dispenser nozzle 26 in the x-, y-, and z-axes.

Tank 32 may differ in its components and composition depending on the type of space filling fluid to be used. If the space filling fluid is solid at room temperature, tank 32 may include heating elements that keep the space filling fluid in the liquid state so that it may flow to dispenser nozzle 26. If the space filling fluid is a liquid at room temperature and its curing is achieved by chemical reaction by mixing a two reactants together, tank 26 may comprise multiple chambers to house the two reactants. In this embodiment, tube 33 may comprise a separate tube for each of the reactants such that the reactants mix just prior to being dispensed at dispenser nozzle 26. In these embodiments, the two reactants may include an epoxy resin and a slow hardener. In other embodiments, the space filling fluid may be a liquid at room temperature that hardens upon exposure to light. In these embodiments, tank 32 and tube 33 may be opaque to prevent hardening prior to the space filling fluid being dispensed at dispenser nozzle 26. In these embodiments, the space filling fluid may be a photo-resin that is cured by exposure to ultraviolet light. Tank 32, tube 33, dispenser head housing 25 and dispenser nozzle 26, together, may correspond to dispenser 603.

The following is a table illustrates simulations of fabricating a cube according to SFF and FDM with differing infill percentages.

Assumptions for Printing Cube to Estimate and
Compare SFF Speed vs FPM at Various Infill

| | | | | | |
|---|---|---|---|---|---|
| Sides | 100 | mm | | | |
| Volume | 1000000 | mm³ | | | |
| FDM Line Width | 0.4 | mm | | | |
| FDM Layer Height | 0.2 | mm | | | |
| FDM speed | 100 | mm/s | | | |
| FDM vol/time | 8 | mm³/s | | | |
| Shell Thickness | 1 | mm | | | |
| Fill Material Cure Time overhead | 1200 | s | | | |
| Top or Bottom Plate Vol | 10000 | mm³ | | | |
| Each of 4 Side Wall Vol | 9702 | mm³ | | | |
| Inner Space Vol | 941192 | mm³ | | | |
| Shell only FDM Print Vol | 58808 | mm³ | | | |
| Shell only FDM Print + cure time | 8,551 | s | or | 2 | hrs |
| SFF vs FDM at Infill Percentage | 100% | | | | |
| Solid FDM Print Vol | 1,000,000 | mm³ | | | |
| Solid Print Time | 125,000 | s | or | 35 | hrs |
| Shell & Fill speedup | 15 | X | | | |
| SFF vs FDM at Infill Percentage | 50% | | | | |
| Solid FDM Print Vol | 529,404 | mm³ | | | |
| Solid Print Time | 66,176 | s | or | 18 | hrs |
| Shell & Fill speedup | 8 | X | | | |
| SFF vs FDM at Infill Percentage | 20% | | | | |
| Solid FDM Print Vol | 247,046 | mm³ | | | |
| Solid Print Time | 30,881 | s | or | 9 | hrs |
| Shell & Fill speedup | 4 | X | | | |
| SFF vs FDM at Infill Percentage | 10% | | | | |
| Solid FDM Print Vol | 152,927 | mm³ | | | |
| Solid Print Time | 19,116 | s | or | 5 | hrs |
| Shell & Fill speedup | 2 | X | | | |

As shown above, the simulated object to be fabricated is a cube with sides of 100 mm. Various other parameters are assumed in the simulations, such as an FDM line width of 0.4 mm and a layer height of 0.2 mm. It is also assumed that the cure time of the space filling fluid is 1200 seconds. According to the simulations, it would take an SFF process 8,551 second to complete the cube. In contrast, it would take an FDM with 100%, 50%, 20%, and 10% infill 125,00 seconds, 66,176 seconds, 30,881, and 19,116 seconds, respectively, to fabricate the simulated cube. SFF is thus roughly 15×, 8×, 4×, and 2× faster than FDM at 100%, 50%, 20%, and 10% infill, respectively.

The above description illustrates various embodiments of the present invention along with examples of how aspects of the present invention may be implemented. The above examples and embodiments should not be deemed to be the only embodiments and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method for fabricating a three-dimensional object, comprising:
depositing, by a shell builder, a first material to form a base of a shell of the three-dimensional object;
depositing, by the shell builder, the first material to form a wall of the shell of the three-dimensional object;
dispensing space filling fluid into a space defined by the shell using a dispenser; and
depositing, by the shell builder, the first material on top of the space filling fluid to form a top layer of the three-dimensional object.

2. The method of claim 1, wherein said depositing the first material to form the wall includes depositing a plurality of layers of the wall, wherein said dispensing space filling fluid includes dispensing a plurality of volumes of the space filling fluid.

3. The method of claim 2, wherein said depositing the plurality of layers of the wall alternates with said depositing the plurality of volumes of the space filling fluid.

4. The method of claim 1, wherein the space filling fluid hardens into a solid before said depositing the first material to form the top layer such that the solid provides support for the top layer.

5. The method of claim 1, further comprising:
depositing the first material to form an overhang; and
dispensing the space filling fluid that when hardened supports the overhang.

6. The method of claim 1, wherein said depositing the first material and said dispensing the space filling fluid occurs concurrently for at least a portion of said fabricating the three-dimensional object.

7. The method of claim 1, wherein the space filling fluid provides support for the wall during at least a portion of said depositing the first material to form the wall.

8. A 3-dimensional (3D) printer for fabricating a 3D object, comprising:
a shell builder for depositing a first material to form a shell; and
a dispenser for dispensing a space filling fluid.

9. The 3D printer of claim 8, wherein:
the shell builder is configured to deposit the first material to form a base of the shell of the 3D object;
the shell builder is further configured to deposit the first material to form a wall of the shell of the three-dimensional object;
the dispenser is further configured to dispense the space filling fluid into the shell; and
the shell builder is further configured to deposit the first material on top of the space filling fluid to form a top layer of the shell on top of the wall and the space filling fluid.

10. The 3D printer of claim 9, wherein the shell builder deposits a plurality of layers of the wall and wherein the dispenser dispenses a plurality of volumes of the space filling fluid.

11. The 3D printer of claim 10, wherein the 3D printer alternates between the shell builder depositing the plurality of layers of the shell and the dispenser dispensing the plurality of volumes of the space filling fluid.

12. The 3D printer of claim 9, wherein the space filling fluid hardens into a solid before the shell builder deposits the first material to form the top layer such that the solid provides support for the top layer.

13. The 3D printer of claim 9, wherein the shell builder deposits the first material and the dispenser dispenses the space filling fluid concurrently for at least a portion of time.

14. The 3D printer of claim 9, wherein the shell builder is configured to deposit the first material and the dispenser is configured to dispense the space filling fluid concurrently for at least a portion of said fabricating the 3D object.

15. A non-transitory computer-readable medium storing a program executable by at least one processing unit of a device, the program comprising sets of instructions for causing a 3-dimensional printer to:
deposit, by a shell builder, a first material to form a base of a shell of the three-dimensional object;
deposit, by the shell builder, the first material to form a wall of the shell of the three-dimensional object;
dispense space filling fluid into the shell using a dispenser; and
deposit, by the shell builder, the first material on top of the space filling fluid to form a top layer of the three-dimensional object.

16. The non-transitory machine-readable medium of claim 15, wherein said depositing the first material to form the wall includes depositing a plurality of layers of the wall, wherein said dispensing space filling fluid includes dispensing a plurality of volumes of the space filling fluid.

17. The non-transitory machine-readable medium of claim 16, wherein said depositing the plurality of layers of the wall alternates with said depositing the plurality of volumes of the space filling fluid.

18. The non-transitory machine-readable medium of claim 16, wherein said depositing the plurality of layers of the wall occurs concurrently with said depositing the plurality of volumes of the space filling fluid for at least a portion of said fabricating the 3D object.

19. The non-transitory machine-readable medium of claim 15, wherein the space filling fluid hardens into a solid before said depositing the first material to form the top layer such that the space filling fluid provides support for the top layer.

20. The non-transitory machine-readable medium of claim 15, further comprising instructions to cause the 3D printer to:
deposit the first material to form an overhang; and
dispense the space filling fluid that when hardened supports the overhang.
